(19) United States
(12) Patent Application Publication
(10) Pub. No.: US 2025/0102841 A1
(43) Pub. Date: Mar. 27, 2025

(54) FABRICATING NON-LIGHT-EMITTING VARIABLE TRANSMISSION LAMINATES

(71) Applicant: SAGE ELECTROCHROMICS, INC., Faribault, MN (US)

(72) Inventors: Robert NEWCOMB, Minneapolis, MN (US); Nathaniel James Lawson, Faribault, MN (US)

(21) Appl. No.: 18/889,350

(22) Filed: Sep. 18, 2024

Related U.S. Application Data
(60) Provisional application No. 63/584,620, filed on Sep. 22, 2023.

(51) Int. Cl. G02F 1/13; G02F 1/153

(52) U.S. Cl. CPC G02F 1/1309; G02F 1/1533

(57) ABSTRACT

A method of repairing an electroactive laminate is disclosed. The method can include locating a defect in the electroactive laminate and laser ablating around the defect using laser pulses in a pattern, where a first laser pulse is followed by a second laser pulse in succession, and wherein the pattern comprises a space between any two laser pulses being fired in succession, and wherein the pattern comprises overlapping pulses between a pulse fired in a first circumferential pass and a pulse fired in a second circumferential pass.

### CROSS-REFERENCE TO RELATED APPLICATION(S)

This application claims priority under 35 U.S.C. § 119 (e) to U.S. Provisional Application No. 63/584,620, entitled “FABRICATING NON-LIGHT-EMITTING VARIABLE TRANSMISSION LAMINATES,” by Robert NEWCOMB et al., filed Sep. 22, 2023, which is assigned to the current assignee hereof and incorporated herein by reference in its entirety.

### FIELD OF THE DISCLOSURE

The present disclosure is directed to forming a non-light-emitting variable transmission laminate device and specifically for defect repair in those laminate devices.

### BACKGROUND

A non-light-emitting variable transmission device can reduce glare and the amount of sunlight entering a room. During the fabrication process of the non-light-emitting variable transmission device, defects can be formed which reduce yield, form an electrical short, affect the appearance of the device (e.g., non-uniform tinting), or reduce the operational lifetime of the device. As such, there is a need for improvement in fabricating non-light-emitting, variable transmission devices and laminates.

### BRIEF DESCRIPTION OF THE DRAWINGS

Embodiments are illustrated by way of example and are not limited in the accompanying figures.

FIG. 1 shows a cross-sectional view of an electroactive device, in accordance with one embodiment.

FIG. 2 shows a method of repairing a defect, according to one embodiment.

FIGS. 3A-3C include an illustration of a top view of an electroactive device with a defect at various stages of repair.

FIG. 4 includes an illustration of a cross-sectional view of a portion of a substrate with a defect repair, according to one embodiment.

FIGS. 5A-5B show portions of electroactive devices having undergone two different repair processes.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The terms “normal operation” and “normal operating state” refer to conditions under which an electrical component or device is designed to operate. The conditions may be obtained from a data sheet or other information regarding voltages, currents, capacitances, resistances, or other electrical parameters. Thus, normal operation does not include operating an electrical component or device well beyond its design limits.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

Manufacturing an electrochromic laminate has unique challenges with respect to defects. In one embodiment, a laminate can be electrochromic material and laminate material between two substrates. In another embodiment, a laminate can be an assembly where two or more substrates are joined with a polymer based interlayer material. Defects that occur during the manufacturing of electroactive laminates can cause optical defects in the final device appearance. In non-laminated electroactive devices, a repair process ablates material surrounding a defect to repair such defect. The encapsulation of electrochromic devices within laminate assemblies introduces additional challenges related to laser ablation repair process. Electroactive laminates can include non-light-emitting, variable transmission devices, electrochromic devices, and liquid crystal devices. Since the defects are trapped in the laminate assembly, pressure can build up in the stack as part of the repair process, and lead to film delamination and bubble formation which in turn leads to poor performance of the electroactive device. The methods for fabricating an electroactive laminate with improved defect repair are disclosed. By successfully repairing the electroactive laminate device, the device can have an increased yield, without an electrical short or other defect that would affect the appearance and performance of the device, and an increased operational lifetime.

Embodiments as illustrated in the figures and described below help in understanding particular applications for implementing the concepts as described herein. The embodiments are exemplary and not intended to limit the scope of the appended claims.

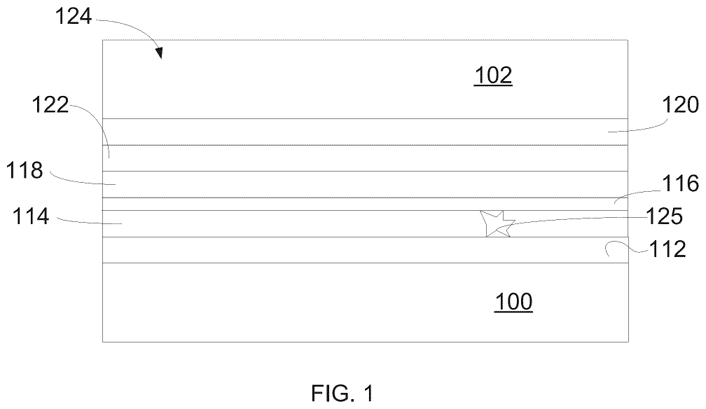

Although not desired, during manufacturing, an electroactive device may be formed that contains a defect. FIG. 1 includes a cross-sectional view of a portion of an electroactive device with a stack of layers, according to one embodiment. In one embodiment, the electroactive device 124 can be a non-light-emitting, variable transmission device. In one embodiment, the electroactive device 124 can include an electrochromic material and an interlayer that are between two substrates. In another embodiment, the electroactive device 124 can include a first transparent conductive layer 112, a cathodic electrode layer 114, an anodic electrode layer 118, a second transparent conductive layer 122, and a laminate layer 120. In one embodiment, the device 124 can also include an ion conducting layer 116 between the cathodic electrode layer 114 and the anodic electrode layer 118. In another embodiment, the electroactive device 124 can include a first substrate, a second substrate, a first transparent conductive layer between the first and second substrate, a second transparent conductive layer between the first and second substrate, a first electrochromic material between the first and second transparent conductive layers, a second electrochromic material between the first and second transparent conductive layers, and a laminate layer between the first and second electrochromic materials. The first transparent conductive layer 112 can be between a first substrate 100 and a second substrate 102. The cathodic electrode layer 114 can be between the first transparent conductive layer 112 and the anodic electrode layer 118. The anodic electrode layer 118 can be between the cathodic electrode layer 114 and the second transparent conductive layer 122. The laminate layer 120 can be on the second transparent conductive layer 122. In one embodiment, the laminate layer 120 can include an electrically insulating material. In one embodiment, the laminate layer 120 can include a material selected from the group consisting of a polyurethane, polyvinyl butyral (PVB), ionomers such as ionoplast like SentryGlas Plus (SGP), ethylene vinyl acetate (EVA), silicone based optically clear resin, and acrylic based optically clear resin. In another embodiment, the laminate layer 120 can include a liquid or gel-like polymer. In another embodiment, the laminate layer 120 may contain the electrochromic material. In another embodiment, the laminate layer 120 may contain a laminating adhesive film.

The first substrate 100 and the second substrate 102 can each include a glass substrate, a sapphire substrate, an aluminum oxynitride substrate, a spinel substrate, or a transparent polymer. In a particular embodiment, the first substrate 100 and the second substrate 102 can be float glass or a borosilicate glass and have a thickness in a range of 0.025 mm to 4 mm thick. In another particular embodiment, the first substrate 100 and/or the second substrate 102 can include ultra-thin glass that is a mineral glass having a thickness in a range of 10 microns to 300 microns.

The first transparent conductive layer 112 and second transparent conductive layer 122 can include a conductive metal oxide or a conductive polymer. Examples can include a indium oxide, tin oxide or a zinc oxide, either of which can be doped with a trivalent element, such as Sn, Sb, Al, Ga, In, or the like, or a sulfonated polymer, such as poly (3,4-ethylenedioxythiophene), or the like, or sulfonated polyaniline and polypyrrole, or one or several metal layer(s) or a metal mesh or a nanowire mesh or graphene or carbon nanotubes or a combination thereof. The transparent conductive layers 112 and 122 can have the same or different compositions.

The cathodic layer 114 and the anodic layer 118 can be electrode layers. In one embodiment, the cathodic layer 114 can be an electrochromic layer. In another embodiment, the anodic layer 118 can be a counter electrode layer. The cathodic electrode layer 114 can include an inorganic metal oxide material, such as WO₃, V₂O₅, MoO₃, Nb₂O₅, TiO₂, CuO, Ir₂O₃, Cr₂O₃, Co₂O₃, Mn₂O₃, or any combination thereof and have a thickness in a range of 20 nm to 2000 nm. The anodic electrode layer 118 can include any of the materials listed with respect to the cathodic electrode layer 114 and may further include nickel oxide (NiO, Ni₂O₃, or combination of the two) or iridium oxide, and Li, Na, H, or another ion and have a thickness in a range of 20 nm to 1000 nm.

The ion conductive layer 116 (sometimes called an electrolyte layer) can be optional and can have a thickness in a range of 1 nm to 1000 nm in case of an inorganic ion conductor or 5 microns to 1000 microns in case of an organic ion conductor. The ion conductive layer 116 can include a silicate with or without lithium, aluminum, zirconium, phosphorus, boron; a borate with or without lithium; a tantalum oxide with or without lithium; a lanthanide-based material with or without lithium; another lithium-based ceramic material particularly LixMOyNz where M is one or a combination of transition metals or the like.

Although not desired, a defect, such as a particle or other contaminate, can be introduced into the electroactive device 124. As seen in FIG. 1, while depicted in the cathodic electrode layer 114, the defect could be in other layers of the electroactive device 124. In one embodiment, the defect 125 may be located between any of the other layers or between the substrate 100 and the second conductive layer 122. In one embodiment, the defect 125 can be in the anodic electrode layer 118. In another embodiment, the defect 125 can be in the ion conductive layer 116. The defect 125 can be a particle or other contaminate that can cause a short within the electroactive device 124. The defect 125 may be from a patterning sequence, laser scribes, from a substrate handling tool, from a coating on a deposition chamber or material that breaks away during transferring the substrate into or out of the deposition tool or during a pump down or back fill cycle, or the like. The defect 125 may be formed during manufacturing of the electroactive device 124 and other layers can be deposited over the defect 125 without being detected until the deposition of the entire device is complete.

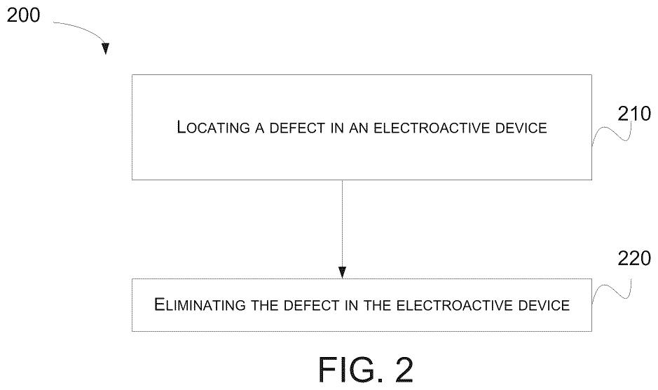

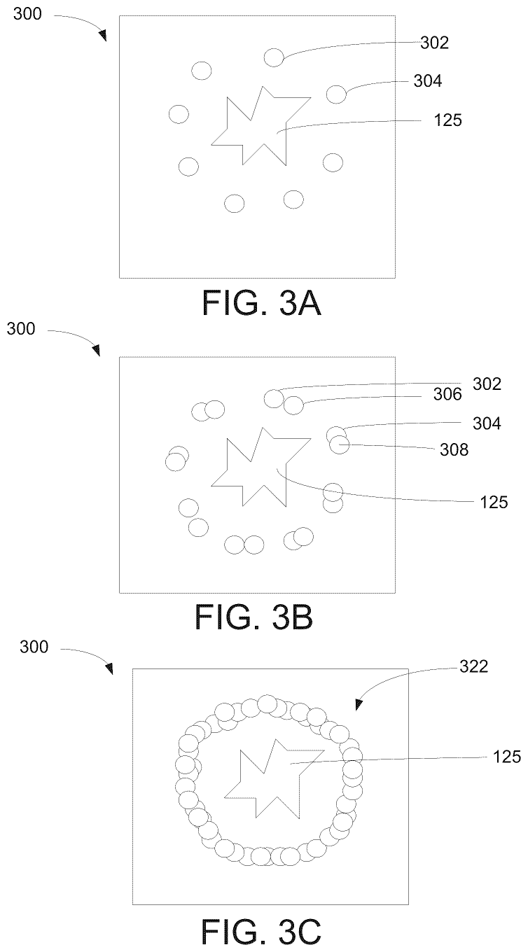

As will be described in more detail with respect to FIGS. 2 and 3, repairing the defect within the electroactive device 124 according to procedures described herein can reduce the likelihood of failure of the electroactive device and prevent electrical shorts within the device. As seen in FIG. 2, a flow diagram 200 for eliminating a defect in an electroactive device, in accordance with one embodiment is seen. The process below is discussed in conjunction with an electroactive device, as seen in FIG. 3.

In operation, as a result of manufacturing, the electroactive device 124 can have a defect 125 within one of the layers. Not all devices that are manufactured contain a defect. Accordingly, the formation of the electroactive device and repair can begin at operation 210 by locating a defect within the electroactive device 124. In one embodiment, the defect can be within any of the layers between the substrate 100 and laminate layer 120. The defect may be detected by running current through the electroactive device 124 after the device has gone through the manufacturing process. During operation, an electroactive transmission device can operate with voltages on bus bars (not seen) being in a range of 0 V to 3 V. Other voltage may be used with the electroactive device or if the composition or thicknesses of layers within an electrochromic stack are changed. The voltages on bus bars may both be positive (1 V to 4 V), both negative (−5 V to −2 V), or a combination of negative and positive voltages (−1 V to 2 V), as the voltage difference between bus bars are more important than the actual voltages. Furthermore, the voltage difference between the bus bars may be less than or greater than 3 V. After reading this specification, skilled artisans will be able to determine voltage differences for different operating modes to meet the needs or desires for a particular application. The embodiments are exemplary and not intended to limit the scope of the appended claims. In an embodiment, locating the defect can occur through visual inspection. For example, the defect may be visible to the human eye or with the use of one or more tools or systems. In another embodiment, locating the defect can be performed with equipment.

At operation 220, the defect 125 may be eliminated from the electroactive device 124. The device 124 can be a laminate. In one embodiment, eliminating the defect can be to eliminate the short caused by the defect 125. In one embodiment, eliminating the defect 125 can be to ablate one or more of the layers of the electroactive laminate device 124 that surround the defect 125. In one embodiment, the laser can ablate at least one of the first transparent conductive layer 112 or the second transparent conductive layer 122. In one embodiment, removing the defect can be performed with a full spectrum laser. The laser can ablate one or more layers of the electroactive laminate device 124 that surround the defect 125. In a more particular embodiment, the laser is operated with pulse duration between 200 fs and 10 ns, such as between 250 fs and 1250 fs, or such as between 300 fs and 1000 fs. In yet a more particular embodiment, the laser is operated with a wavelength between 450 nm and 600 nm, between 500 nm and 550nm, or between 510 nm and 525 nm. In yet a further embodiment, the laser is operated with a wavelength of approximately 515 nm. In an embodiment, the laser is operated at a same pulse duration during the entire removal step. In another embodiment, the laser is operated at a same wavelength during the entire removal step. In a different embodiment, the laser can be operated with a variable pulse duration, a variable wavelength, or a combination thereof. In one embodiment, the laser can be fired from the side of the device that contains the substrate 100. In other words, the laser can be fired through the substrate 100. In another embodiment, the laser can be fired from a side of the device that contains the substrate 102. Utilizing a laser beam that continuously circumscribes around the defect to eliminate the defect in a laminated device causes delamination and bubbling thereby causing a worse defect in the electroactive device. In short, instead of eliminating the defect, using a continuous beam causes more detrimental effects. The present disclosure focuses on utilizing more than one laser pulse in a pattern.

FIGS. 3A-3C show a top view of an electroactive laminate during various steps in the process of eliminating the defect within an electroactive device. The electroactive device 300 can be similar to the electroactive device described above with respect to FIG. 1. In one embodiment, before laser ablating the defect, the substrate 100 can be heated to between 40° C. and 90° C. In another embodiment, the laser ablation can occur at a temperature between 10° C. and 40° C.

In one embodiment, a first laser pulse 302 is followed by a second laser pulse 304, where there is a space between the first laser pulse 302 and the second laser pulse 304. The laser pulses form a laser spot of ablated material on the device. In one embodiment, the pulse overlap between the first laser pulse 302 and the second laser pulse 304 is about zero. In one embodiment, the pulse overlap between the first laser pulse 302 and the second laser pulse 304 is a negative overlap. In one embodiment, the pulse overlap between two sequentially fired laser pulses can be about zero. In one embodiment, the pulse overlap between two sequentially fired laser pulses can be negative. The laser pulses follow in succession in a circumferential manner in one pass around the defect 125. In one embodiment, the distance between successive laser pulses in one particular pass can be between 0.5 nm and 500 nm. The method continues by firing one or more laser pulses circumferentially around the defect in two or more passes. In other words, the pulses can travel 360 degrees around the defect 125 in one turn or pass and the pulses can take more than one turn or pass around the defect 125. A turn or pass can include a starting point and ending point being in about the same location. In other words, a path of the laser can form a closed loop. In another embodiment, the laser can be maintained in a steady state and the electroactive device 300 can be rotated relative to the laser.

As seen in FIG. 3B, a third laser pulse 306 can be fired in a second turn around the defect. The third laser pulse 306 can be the first laser pulse of a second pass. In other words, even though the second laser pulse 304 is fired before the third laser pulse 306, the third laser pulse 306 is closer to the first laser pulse 302 than the second laser pulse 304. In one embodiment, a second pass of the laser can form a closed loop around the defect 125. In one embodiment, the third laser pulse 306 is closer to the second laser pulse 304 than the first laser pulse 302 and is fired during a second turn or pass around the defect 125. In one embodiment, a pulse overlap between the first laser pulse 302 and the third laser pulse 306 can be greater than zero. In one embodiment, the third laser pulse 306 can overlap the first laser pulse 302 between 1% and 99%. In one embodiment, the third laser pulse 306 can overlap the first laser pulse 302 by between 10% and 90%. In one embodiment, the one or more laser pulses that are fired in a second turn around the defect 125 can overlap with one or more of the laser pulses that are fired in the first turn around the defect 125. As can be seen in FIG. 3B, a fourth laser pulse 308 can overlap a second laser pulse 304. The fourth laser pulse 308 can be a second pulse of the second pass. In one embodiment, the pulses are fired in at least two rounds. As seen in FIG. 3C, once all the spaces between the individual pulses have been eliminated, a circumferential scribe 322 can be made around the defect 125 in order to electrically isolate the defect 125 from the rest of the electroactive device 300. While shown in FIGS. 3A-3C as circular, the laser pattern that surrounds and isolates the defect 125 can be any geometric shape, such as a square, rectangular, triangular, polygonal, etc.

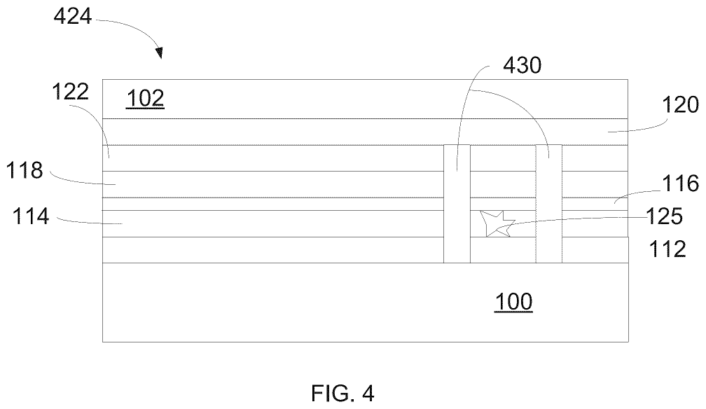

FIG. 4 is an illustration of a cross-sectional view of the electroactive device 424 after the defect repair has been completed. As can be seen in FIG. 4, after undergoing the method described above, the defect 125 is electrically isolated from the rest of the electroactive device 424. In one embodiment, the defect 125 remains in the electroactive device 424. In one embodiment, the laser can ablate one or more layers of the electroactive device 424 in a pattern as described above. The pattern can include individual spots 430 or beams that overlap in a circumferential manner around the defect 125, as seen in FIG. 3C. In one embodiment, the one or more individual laser spots 430 are not uniform. In one embodiment, the one or more laser spots 430 have varying depths. In one embodiment, the one or more laser spots 430 can have different sizes. In one or more embodiments, the one or more laser spots 430 can have different shapes. In one embodiment, the one or more laser spots 430 can have different sizes and different shapes.

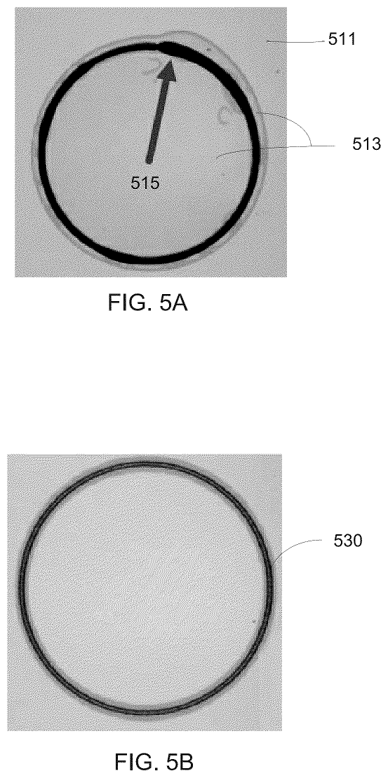

FIGS. 5A and 5B illustrate an optical microscope image of two different methods of laser ablation used to repair a defect (not shown) in an electroactive laminate device. FIG. 5A shows a continuous pulsed laser ablation process completed in at least one pass using pulse overlap greater than zero. FIG. 5B shows a pulsed laser ablation process utilizing the method described above, where a pulse overlap is less than zero between any two sequential laser pulses fired in a single pass. A trench 530 is formed around a repaired area that contains a defect. The trench 530 can be non-uniform. In one embodiment, the trench 530 can have varying depths. In another embodiment, the trench 530 can have varying widths. In another embodiment, the trench 530 can have a double ring configuration formed from individual laser spots. As can be seen in FIG. 5A, significant damage 515 to the laminate layer and delamination 513 occurs. Delamination 513 is seen in FIG. 5A as a lighter or more clear color within and surrounding the circle created by the laser as compared to the color 511 within the functioning area of the device.

Embodiments as described above can provide benefits over other systems with electroactive devices. Repairing a defect using pulses that are fired in a pattern that circumferentially surrounds the defect, as described above, can eliminate delamination and bubbling problems otherwise seen in a continuous ablation process.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A method of repairing an electroactive assembly is disclosed. The method can include locating a defect in the electroactive assembly; and laser ablating around the defect using laser pulses in a pattern, where the pattern can include a first laser pulse followed by a second laser pulse in succession, and where the pattern can include a space between any two laser pulses being fired in succession.

Embodiment 2. The method of embodiment 1, where the electroactive assembly further can include electrochromic material, an interlayer, a first substrate, and a second substrate, where the electrochromic material and the interlayer are both between the first substrate and the second substrate.

Embodiment 3. The method of embodiment 2, where in the interlayer can include a material selected from the group consisting of a polyurethane, polyvinyl butyral (PVB), ionoplast like SentryGlas Plus (SGP), and ethylene vinyl acetate (EVA).

Embodiment 4. The method of embodiment 1, where the electroactive assembly further can include a first substrate, a cathodic layer, an anodic layer, an interlayer, a first transparent conductive layer, and a second transparent conductive layer.

Embodiment 5. The method of embodiment 1, where the laser is operated with a wavelength between 450 nm and 600 nm, such as between 500 nm and 550 nm, or between 510 nm and 525 nm.

Embodiment 6. The method of embodiment 1, where the first laser pulse does not overlap the second laser pulse.

Embodiment 7. The method of embodiment 1, where laser ablating around a defect is accomplished in at least two circumferential passes.

Embodiment 8. The method of embodiment 7, where the pattern can include overlapping pulses between a pulse fired in a first pass and a pulse fired in a second pass.

Embodiment 9. The method of embodiment 8, where a first pass can include moving the laser 360 degrees around the defect from a first starting point.

Embodiment 10. The method of embodiment 9, where a second pass can include moving the laser 360 degrees around the defect from a second starting point, where the first starting point is different from the second starting point.

Embodiment 11. The method of embodiment 1, where before laser ablating the defect, the substrate is heated to between 40° C. and 90° C.

Embodiment 12. The method of embodiment 1, where laser ablating the defect occurs at a temperature between 10° C. and 40° C.

Embodiment 13. The method of embodiment 1, where a pulse overlap of the first pulse and the second pulse is about zero.

Embodiment 14. The method of embodiment 1, where a pulse overlap of the first pulse and the second pulse is negative.

Embodiment 15. The method of embodiment 1, where the laser is operated with a pulse duration between 200 fs and 10 ns, such as between 250 fs and 1250 fs, or between 300 fs and 1000 fs.

Embodiment 16. The method of embodiment 4, where the laser pulses ablate at least one of the first transparent conductive layers or the second transparent conductive layer of the electroactive assembly.

Embodiment 17. A process of fabricating an electroactive assembly is disclosed. The process can include forming an electroactive assembly, where the electroactive assembly can include a first substrate, a second substrate, a laminate layer between the first substrate and the second substrate, and electroactive material between the first substrate and the second substrate; detecting a defect in the electroactive assembly; and laser ablating around the defect using at least two laser pulses in a pattern, where a first laser pulse is followed by a second laser pulse in succession, where the pattern can include a space between any two laser pulses being fired in succession, and where the pattern can include overlapping pulses between a pulse fired in a first circumferential pass and a pulse fired in a second circumferential pass.

Embodiment 18. The process of fabricating an electroactive assembly of embodiment 17, where forming the electroactive assembly can include: forming the first transparent conductive layer overlying the first substrate; forming at least one electroactive layer overlying the first transparent conductive layer, where the electroactive layer can include the electroactive material; forming the second transparent conductive layer; forming the laminate layer; and encapsulating the electroactive layer between the first substrate and the second substrate.

Embodiment 19. An electroactive laminate is disclosed. The electroactive laminate can include a first substrate; a second substrate; a first transparent conductive layer between the first substrate and the second substrate; a laminate layer between the first substrate and the second substrate; a second transparent conductive layer between the first substrate and the second substrate; an electroactive material between the first transparent conductive layer and the second transparent conductive layer; and at least one repaired area, where the at least one repaired area can include a circumferential continuous trench and where the trench has a double ring configuration formed by at least two individual laser spots.

Embodiment 20. The electroactive laminate of embodiment 19, where the trench has differing depths.

Embodiment 21. The electroactive laminate of embodiment 19, where the trench is non-uniform.

Embodiment 22. The electroactive laminate of embodiment 19, where the trench has varying widths.

Embodiment 23. The electroactive laminate of embodiment 19, where an area circumscribed by the trench is not delaminated.

Embodiment 24. The electroactive laminate of embodiment 19, where the repaired area further can include a defect within the repaired area and surrounded by the trench.

Embodiment 25. The electroactive laminate of embodiment 19, where the repaired area can include the substrate, the first transparent conductive layer, and the electroactive material at the bottom of the trench.

Embodiment 26. The electroactive laminate of embodiment 19, where the at least two individual laser spots are overlapping.

Embodiment 27. The electroactive laminate of embodiment 26, where a first distance from a center of the defect to a center of the first laser spot is different from a second distance from a center of the defect to a center of the second laser spot.

Embodiment 28. The electroactive laminate of embodiment 27, where each of the at least two individual overlapping laser spots are congruent.

Embodiment 29. The electroactive laminate of embodiment 19, where the electroactive material is a cathodic layer and can include material selected from the group consisting of WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 30. The electroactive laminate of embodiment 19, where the first transparent conductive layer can include indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 31. The electroactive laminate of embodiment 19, further can include an ion-conducting layer over the electroactive material, and where the ion-conducting layer can include lithium, sodium, hydrogen, SiO₂, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 32. The electroactive laminate of embodiment 19, where the electroactive material is a counter electrode layer that can include an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃,a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of repairing an electroactive assembly comprising:
locating a defect in the electroactive assembly; and
laser ablating around the defect using laser pulses in a pattern, wherein the pattern comprises a first laser pulse followed by a second laser pulse in succession, and wherein the pattern comprises a space between any two laser pulses being fired in succession.

2. The method of claim 1, wherein the electroactive assembly further comprises electrochromic material, an interlayer, a first substrate, and a second substrate, wherein the electrochromic material and the interlayer are both between the first substrate and the second substrate.

3. The method of claim 2, where in the interlayer comprises a material selected from the group consisting of a polyurethane, polyvinyl butyral (PVB), ionoplast like SentryGlas Plus (SGP), and ethylene vinyl acetate (EVA).

4. The method of claim 1, wherein the electroactive assembly further comprises a first substrate, a cathodic layer, an anodic layer, an interlayer, a first transparent conductive layer, and a second transparent conductive layer.

5. The method of claim 1, wherein the first laser pulse does not overlap the second laser pulse.

6. The method of claim 1, wherein laser ablating around a defect is accomplished in at least two circumferential passes.

7. The method of claim 6, wherein the pattern comprises overlapping pulses between a pulse fired in a first pass and a pulse fired in a second pass.

8. The method of claim 7, wherein a first pass comprises moving the laser 360 degrees around the defect from a first starting point.

9. The method of claim 8, wherein a second pass comprises moving the laser 360 degrees around the defect from a second starting point, wherein the first starting point is different from the second starting point.

10. A process of fabricating an electroactive assembly, the process comprising:
forming an electroactive assembly, wherein the electroactive assembly comprises a first substrate, a second substrate, a laminate layer between the first substrate and the second substrate, and electroactive material between the first substrate and the second substrate;
detecting a defect in the electroactive assembly; and
laser ablating around the defect using at least two laser pulses in a pattern, wherein a first laser pulse is followed by a second laser pulse in succession, wherein the pattern comprises a space between any two laser pulses being fired in succession, and wherein the pattern comprises overlapping pulses between a pulse fired in a first circumferential pass and a pulse fired in a second circumferential pass.

11. The process of fabricating an electroactive assembly of claim 10, wherein forming the electroactive assembly comprises:
forming the first transparent conductive layer overlying the first substrate;
forming at least one electroactive layer overlying the first transparent conductive layer, wherein the electroactive layer comprises the electroactive material;
forming the second transparent conductive layer;
forming the laminate layer; and
encapsulating the electroactive layer between the first substrate and the second substrate.

12. An electroactive laminate comprising:
a first substrate;
a second substrate;
a first transparent conductive layer between the first substrate and the second substrate;
a laminate layer between the first substrate and the second substrate;
a second transparent conductive layer between the first substrate and the second substrate;
an electroactive material between the first transparent conductive layer and the second transparent conductive layer; and
at least one repaired area, wherein the at least one repaired area comprises a circumferential continuous trench and wherein the trench has a double ring configuration formed by at least two individual laser spots.

13. The electroactive laminate of claim 12, wherein the trench has differing depths.

14. The electroactive laminate of claim 12, wherein the trench is non-uniform.

15. The electroactive laminate of claim 12, wherein the trench has varying widths.

16. The electroactive laminate of claim 12, wherein an area circumscribed by the trench is not delaminated.

17. The electroactive laminate of claim 12, wherein the repaired area further comprises a defect within the repaired area and surrounded by the trench.

18. The electroactive laminate of claim 12, wherein the repaired area comprises the substrate, the first transparent conductive layer, and the electroactive material at the bottom of the trench.

19. The electroactive laminate of claim 12, wherein the at least two individual laser spots are overlapping.

20. The electroactive laminate of claim 19, wherein a first distance from a center of the defect to a center of the first laser spot is different from a second distance from a center of the defect to a center of the second laser spot.
